(19) United States
(12) Patent Application Publication
(10) Pub. No.: US 2018/0291268 A1
(43) Pub. Date: Oct. 11, 2018

(54) MANUFACTURING METHOD OF QUANTUM DOT

(71) Applicants: SAMSUNG DISPLAY CO., LTD., Yongin-si (KR); KOREA INSTITUTE OF SCIENCE AND TECHNOLOGY, Seoul (KR); KOREA ADVANCED INSTITUTE OF SCIENCE AND TECHNOLOGY, Daejeon (KR)

(72) Inventors: Min Ki NAM, Yongin-si (KR); Kyoung Won PARK, Yongin-si (KR); Keun Chan OH, Yongin-si (KR); Jae Jin LYU, Yongin-si (KR); Baek Hee LEE, Yongin-si (KR); Hyeok Jin LEE, Yongin-si (KR); Jaikyeong KIM, Yongin-si (KR); Heesuk KIM, Yongin-si (KR); Wan Ki BAE, Yongin-si (KR); Doh Chang LEE, Yongin-si (KR)

(21) Appl. No.: 15/860,902

(22) Filed: Jan. 3, 2018

(30) Foreign Application Priority Data
Apr. 6, 2017 (KR) 10-2017-0044795

(51) Int. Cl. C09K 11/88

(52) U.S. Cl. CPC C09K 11/883

(57) ABSTRACT

A method of manufacturing a quantum dot, the method including preparing a CdS/CdSe/CdS quantum dot that includes a CdS-containing first core, a CdSe-containing second core, and a CdS-containing shell; forming a Cu₂S/Cu₂Se/Cu₂S quantum dot by injecting the CdS/CdSe/CdS quantum dot into a solution containing a Cu precursor; and forming a ZnS/ZnSe/ZnS quantum dot by injecting the Cu₂S/Cu₂Se/Cu₂S quantum dot into a solution containing a Zn precursor.

### CROSS-REFERENCE TO RELATED APPLICATION

Korean Patent Application No. 10-2017-0044795, filed on Apr. 6, 2017, in the Korean Intellectual Property Office, and entitled: “Manufacturing Method Of Quantum Dot,” is incorporated by reference herein in its entirety.

### BACKGROUND

### 1. Field

Embodiments relate to a manufacturing method of a quantum dot.

### 2. Description of the Related Art

Materials may have physical characteristics, that may not be observed in a bulk state, as the sizes thereof become smaller in nanometers. For example, when the nano sizes and the shapes of the materials are changed, the characteristics may also be changed.

Nano materials may include a quantum dot (QD), which is a semiconductor material having a nano size of a diameter of about 2 to 10 nm. This material is a material that exhibits a quantum confinement effect in which the electron movement characteristic in the bulk state semiconductor material is more restricted when the material becomes smaller than or equal to a predetermined size, and thus the emission wavelength is different from that in the bulk state. When the quantum dot reaches an energy excited state by receiving light from an excitation source, energy according to a corresponding energy gap is emitted by itself. Accordingly, when the size of the quantum dot is controlled, the corresponding band gap may be controlled and energy in various wavelength bands may be obtained, and as a result, completely different optical, electrical and magnetic properties from the original properties are exhibited.

### SUMMARY

Embodiments are directed to a manufacturing method of a quantum dot.

The embodiments may be realized by providing a method of manufacturing a quantum dot, the method including preparing a CdS/CdSe/CdS quantum dot that includes a CdS-containing first core, a CdSe-containing second core, and a CdS-containing shell; forming a Cu₂S/Cu₂Se/Cu₂S quantum dot by injecting the CdS/CdSe/CdS quantum dot into a solution containing a Cu precursor; and forming a ZnS/ZnSe/ZnS quantum dot by injecting the Cu₂S/Cu₂Se/Cu₂S quantum dot into a solution containing a Zn precursor.

The ZnS/ZnSe/ZnS quantum dot may include a ZnS/ZnSe-containing core and a ZnS-containing shell, and a thickness of the ZnS-containing shell may be 0.5 nm to 4.0 nm.

A diameter of a ZnS-containing first core in the ZnS/ZnSe/ZnS quantum dot may be 0.5 nm to 4.0 nm, and a thickness of a ZnSe-containing second core in the ZnS/ZnSe/ZnS quantum dot may be 1.0 nm to 4.0 nm.

Forming the Cu₂S/Cu₂Se/Cu₂S quantum dot may be performed at ambient temperature for 1 to 10 seconds.

The solution including the Cu precursor may include Cu ions dispersed in an organic solvent.

The solution including the Cu precursor may include [Cu (CH₃CN)₄]PF₆⁻ dispersed in methanol.

Forming the ZnS/ZnSe/ZnS quantum dot may be performed at a temperature of 220° C. to 270° C. for 4 to 6 minutes.

The solution including the Zn precursor may include Zn ions dispersed in an organic solvent.

The solution including the Zn precursor may include ZnCl₂ dispersed in at least one of oleylamine and 1-octadecene.

The embodiments may be realized by providing a method of manufacturing a quantum dot, the method including preparing a CdSe/CdS quantum dot that includes a CdSe-containing core and a CdS-containing shell; forming a Cu₂Se/Cu₂S quantum dot by injecting the CdSe/CdS quantum dot into a solution containing a Cu precursor; and forming a ZnSe/ZnS quantum dot by injecting the Cu₂Se/Cu₂S quantum dot into a solution containing a Zn precursor.

The ZnSe/ZnS quantum dot may include a ZnSe-containing core and a ZnS-containing shell, and a thickness of the ZnS-containing shell may be 0.5 nm to 9.0 nm.

A diameter of a ZnSe-containing core in the ZnSe/ZnS quantum dot may be 2.5 nm to 4.0 nm.

Forming the Cu₂Se/Cu₂S quantum dot of may be performed at ambient temperature for 1 to 10 seconds.

The solution including the Cu precursor may include Cu ions dispersed in an organic solvent.

The solution including the Cu precursor may include [Cu (CH₃CN)₄]PF₆⁻ dispersed in methanol.

Forming the ZnSe/ZnS quantum dot of is performed at a temperature of 220° C. to 270° C. for 4 to 6 minutes.

The solution including the Zn precursor may include Zn ions dispersed in an organic solvent.

The solution including the Zn precursor may include ZnCl₂ dispersed in at least one of oleylamine and 1-octadecene.

### BRIEF DESCRIPTION OF THE DRAWINGS

Features will be apparent to those of skill in the art by describing in detail exemplary embodiments with reference to the attached drawings in which:

FIG. 1 illustrates a manufacturing process of a quantum dot according to an exemplary embodiment and an image of the quantum dot in each step.

FIG. 2 illustrates an absorption spectrum Abs and an emission spectrum PL of a CdS/CdSe/CdS quantum dot of (a) in FIG. 1.

FIG. 3 illustrates an absorption spectrum Abs and an emission spectrum PL of a ZnS/ZnSe/ZnS quantum dot of (b) in FIG. 1.

FIG. 4 illustrates a diagram of comparing an XRD pattern of the ZnS/ZnSe/ZnS quantum dot manufactured by the manufacturing method of the quantum dot according to the exemplary embodiment with XRD patterns of Zn, Cu, and Cd, respectively.

FIG. 5 illustrates an image of a CdS/CdSe/CdS quantum dot of Experimental Example 1.

FIG. 6 illustrates an image of a ZnS/ZnSe/ZnS quantum dot manufactured in Experimental Example 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. As used herein, the term “or” is not an exclusive term, such that “A or B” includes any and all combinations thereof, e.g., A, B, or A and B.

Hereinafter, a method of manufacturing a ZnS/ZnSe/ZnS quantum dot according to an exemplary embodiment will be described.

A method of manufacturing a ZnS/ZnSe/ZnS quantum dot according to an exemplary embodiment may include, e.g., preparing a CdS/CdSe/CdS quantum dot including a CdS-containing first core, a CdSe-containing second core, and a CdS-containing shell, forming a Cu₂S/Cu₂Se/Cu₂S quantum dot by injecting the CdS/CdSe/CdS quantum dot into a solution containing a Cu precursor, and forming the ZnS/ZnSe/ZnS quantum dot by injecting the Cu₂S/Cu₂Se/Cu₂S quantum dot into a solution containing a Zn precursor.

First, preparing CdS/CdSe/CdS quantum dot including the CdS-containing first core, the CdSe-containing second core, and the CdS-containing shell will be described.

In the CdS/CdSe/CdS quantum dot according to the exemplary embodiment, CdS may be positioned as the first core at a center of the quantum dot, the CdSe-containing second core may be positioned along an outside of the CdS-containing first core, and the CdS-containing shell may be positioned along an outside of the CdSe-containing second core. For example, in the quantum dot according to the exemplary embodiment, the first core and the shell include the same material. In the case of having the structure, stress caused by a difference in lattice constant generated at an interface between the CdSe-containing second core and the CdS-containing shell may be offset or compensated for. For example, stress caused by a difference in lattice constant generated in an interface between CdS (in the first core) and CdSe (in the second core) and stress generated between CdSe (in the second core) and CdS (in the shell) may be offset, thereby minimizing the stress acting on the entire quantum dot. For example, the thicker the shell, the greater the stress due to the difference in lattice constant acting on the core/shell interface, and therefore, it may not be easy to make the shell thicker than or equal to a predetermined thickness. According to an embodiment, when the quantum dot has a triple structure of CdS/CdSe/CdS, the outermost CdS-containing shell may be formed to be thicker. The thick shell may physically protect the quantum dot and may enhance purity of light to be emitted, and may enhance emission efficiency by increasing electron-hole coupling. The effect is the same as the effect even in the case where the CdS/CdSe/CdS quantum dot is ion-exchanged thereafter to form a ZnS/ZnSe/ZnS quantum dot.

In addition, CdS may be formed in a uniformly circular or spherical shape upon nucleation, and accordingly, a CdSe-containing second core or a CdS-containing shell to be formed thereafter may also be uniformly formed in a spherical shape along the spherical CdS-containing first core nucleus. The CdS/CdSe/CdS quantum dot having the spherical shape may become the ZnS/ZnSe/ZnS quantum dot through ion exchange in a subsequent step, and the ZnS/ZnSe/ZnS quantum dot may also have a uniformly spherical shape like the CdS/CdSe/CdS quantum dot. When the quantum dot has the uniformly spherical shape, color purity of emitted light may be enhanced as compared with a quantum dot having an irregular shape.

In this step, a diameter of the CdS-containing first core in the CdS/CdSe/CdS quantum dot may be, e.g., about 0.5 nm to 4.0 nm. In an implementation, a thickness of the CdSe-containing second core may be, e.g., about 1.0 nm to 4.0 nm. In an implementation, a thickness of the CdS-containing shell may be, e.g., about 0.5 nm to 4.0 nm. The CdS-containing shell may become a ZnS-containing shell through ion exchange thereafter, and the thickness of the CdS-containing shell may be similar to the thickness of the finally manufactured ZnS-containing shell.

The diameter of the first core may be in a suitable range to offset the stress between the second core and the shell. Maintaining the diameter of the first core at about 0.5 nm or greater may help ensure that there is sufficient effect of offsetting the stress. Maintaining the diameter of the first core at about 4.0 nm or less may help ensure that the stress between the first core and the second core is not excessively increased.

Maintaining the thickness of the second core at about 1.0 nm or greater may help ensure that the amount of light emitted is sufficient. Maintaining the thickness of the second core at about 4.0 nm or less may help ensure that the size of the quantum dot is not too large.

Maintaining the thickness of the shell at about 0.5 nm or greater may help ensure that the internal core is sufficiently protected, thereby reducing the possibility of a decrease in the emission efficiency. Maintaining the thickness of the shell at about 4.0 nm or less may help ensure that the stress between the shell and the second core is not excessively increased.

Next, the Cu₂S/Cu₂Se/Cu₂S quantum dot may be formed by injecting the CdS/CdSe/CdS quantum dot in the solution containing the Cu precursor. The Cu₂S/Cu₂Se/Cu₂S quantum dot may be formed by ion-exchanging Cd of the CdS/CdSe/CdS quantum dot with Cu ions from the solution.

For example, the CdS/CdSe/CdS quantum dot may be injected into the solution containing the Cu precursor. In an implementation, the injected CdS/CdSe/CdS quantum dot may be dispersed in chloroform. The injection may be performed at room or ambient temperature, and ion exchange may be completed after several seconds elapse. The ion exchange reaction may be performed for 1 second to 10 seconds, and the Cu ions in the solution may be exchanged with Cd in the quantum dot, and the CdS/CdSe/CdS quantum dot may become the Cu₂S/Cu₂Se/Cu₂S quantum dot.

In this step, the solution containing the Cu precursor into which the CdS/CdSe/CdS quantum dot is injected may include an organic solvent. In an implementation, the organic solvent may include, e.g., methanol, or another suitable organic solvent. In an implementation, the Cu precursor may include, e.g., [Cu (CH₃CN)₄]PF₆⁻, or another suitable material that contains Cu ions.

Next, the ZnS/ZnSe/ZnS quantum dot may be formed by injecting the Cu₂S/Cu₂Se/Cu₂S quantum dot into the solution containing the Zn precursor. The ZnS/ZnSe/ZnS quantum dot may be formed by ion-exchanging Cu of the Cu₂S/Cu₂Se/Cu₂S quantum dot with Zn ions from the solution. In an implementation, the solution containing the Zn precursor may be heated at a temperature of, e.g., about 220° C. to 270° C., the Cu₂S/Cu₂Se/Cu₂S quantum dot may be injected into the solution, and then the solution may be maintained at the temperature for about 4 to 6 minutes. In this case, the Zn ions in the solution may be exchanged with Cu in the quantum dot and thus the Cu₂S/Cu₂Se/Cu₂S quantum dot may become the ZnS/ZnSe/ZnS quantum dot. Maintaining the temperature of the solution containing the Zn precursor at about 220° C. or greater may help ensure that the reaction sufficiently occurs. Maintaining the temperature of the solution containing the Zn precursor at about 270° C. or less may help ensure that a uniform ion exchange reaction occurs.

In an implementation, the injection of the Cu₂S/Cu₂Se/Cu₂S quantum dot may be performed quickly, and the Cu₂S/Cu₂Se/Cu₂S quantum dot may be injected in a state of being dispersed in methanol.

In an implementation, the solution containing the Zn precursor may include an organic solvent. The organic solvent may include, e.g., oleylamine or 1-octadecene. In an implementation, the Zn precursor may include, e.g., ZnCl₂.

For example, in the manufacturing method of the quantum dot of an embodiment, the CdS/CdSe/CdS quantum dot may be ion-exchanged with Cu and then ion-exchanged with Zn to manufacture the ZnS/ZnSe/ZnS quantum dot. If a ZnS/ZnSe/ZnS quantum dot were to be directly manufactured without such ion exchange, it could be difficult to laminate a ZnS-containing core having a diameter of several nm and a shell, due to high binding energy of ZnS. Furthermore, due to the low reactivity of ZnS, it could be difficult to realize a uniform and thick ZnS shell. Further, a crystal of ZnS or ZnSe may have an irregular particulate shape (rather than a uniform circle or sphere) during nucleation, the shell to be formed thereafter may also be not uniformly formed, and the surface may be irregular. In a quantum dot having the irregular surface and the non-spherical quantum dot, color purity of emitted light may be deteriorated, as compared with the uniformly spherical quantum dot according to an embodiment. Further, if the ZnS shell were to not be sufficiently thick, the quantum dot could be insufficiently protected from an external environment and the emission efficiency could also be reduced.

For example, with a view toward enhancing the color purity and the emission efficiency, the ZnS/ZnSe/ZnS quantum dot may have a spherical shape and the ZnS-containing shell may have a predetermined thickness. If a ZnS/ZnSe/ZnS quantum dot were to be directly manufactured, the ZnS-containing core could be formed in an irregular shape, and it may be difficult to manufacture the quantum dot having the spherical shape and the thick shell may not be formed due to low reactivity of ZnS.

In the manufacturing method of the ZnS/ZnSe/ZnS quantum dot according to an embodiment, first, the CdS/CdSe/CdS quantum dot may be manufactured and then sequentially ion-exchanged to manufacture the ZnS/ZnSe/ZnS quantum dot. A CdS nucleus may be formed in a uniformly spherical shape, and the entire shape of the CdS/CdSe/CdS quantum dot may also be spherical. Accordingly, the shape of the ZnS/ZnSe/ZnS quantum dot manufactured through ion exchange may also be a uniformly spherical shape. In an implementation, in the process of manufacturing the CdS/CdSe/CdS quantum dot, the thickness of the CdS-containing shell may become or correspond with the thickness of the ZnS-containing shell of the ZnS/ZnSe/ZnS quantum dot, and the ZnS/ZnSe/ZnS quantum dot including the ZnS-containing shell having a predetermined thickness may be manufactured. In an implementation, the thickness of the ZnS-containing shell may be, e.g., about 0.5 nm to 4.0 nm. In an implementation, the thickness of the ZnS-containing shell may be, e.g., 2 nm to 4 nm.

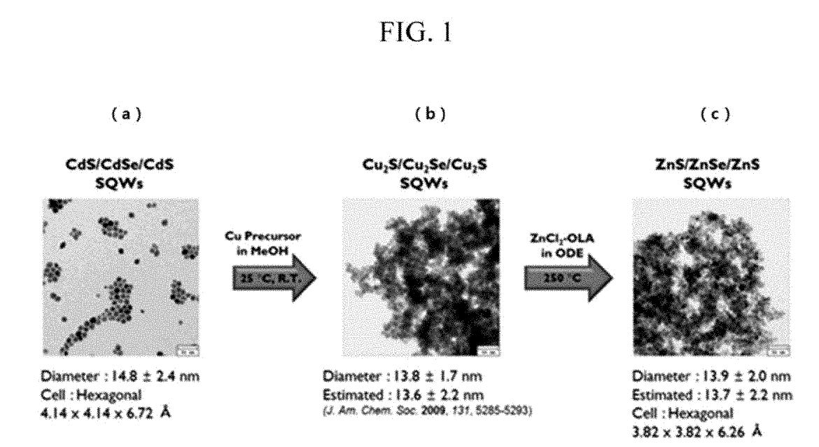

FIG. 1 illustrates a manufacturing process of a quantum dot according to an exemplary embodiment and an image of the quantum dot in each step.

Referring to (a) of FIG. 1, a CdS/CdSe/CdS quantum dot may have a uniform size. Thereafter, referring to (b) of FIG. 1, it may be seen that the CdS/CdSe/CdS quantum dot is ion-exchanged to form a Cu₂S/Cu₂Se/Cu₂S quantum dot. Next, referring to (c) of FIG. 1, it may be seen that the Cu₂S/Cu₂Se/Cu₂S quantum dot is ion-exchanged to form a ZnS/ZnSe/ZnS quantum dot.

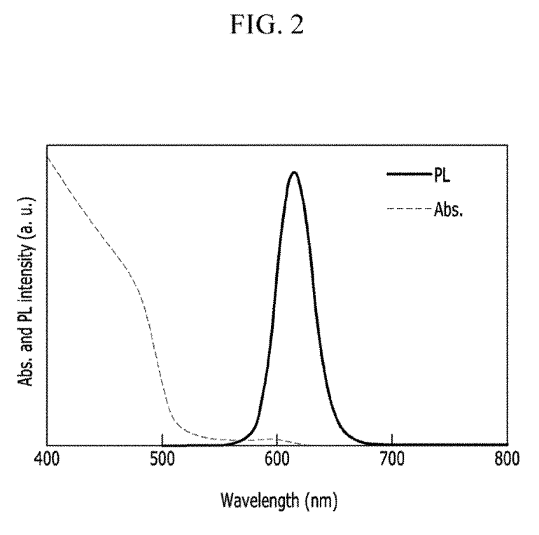

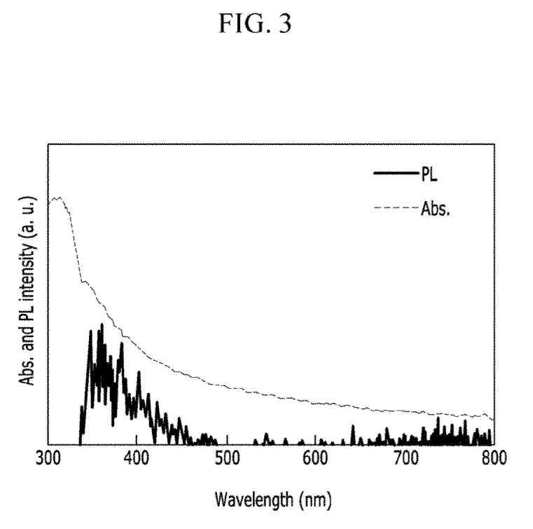

FIG. 2 illustrates an absorption spectrum Abs and an emission spectrum PL of the CdS/CdSe/CdS quantum dot of (a) of FIG. 1. In addition, FIG. 3 illustrates an absorption spectrum Abs and an emission spectrum PL of the ZnS/ZnSe/ZnS quantum dot of (c) of FIG. 1. Referring to FIGS. 2 and 3, it may be seen that the CdS/CdSe/CdS quantum dot emits light having a central wavelength of about 650 nm, but after ion exchange, and the ZnS/ZnSe/ZnS quantum dot emits light having a central wavelength of about 350 nm. For example, it may be seen that the material configuring the quantum dot is changed by ion exchange and as a result, the emitted light is also changed.

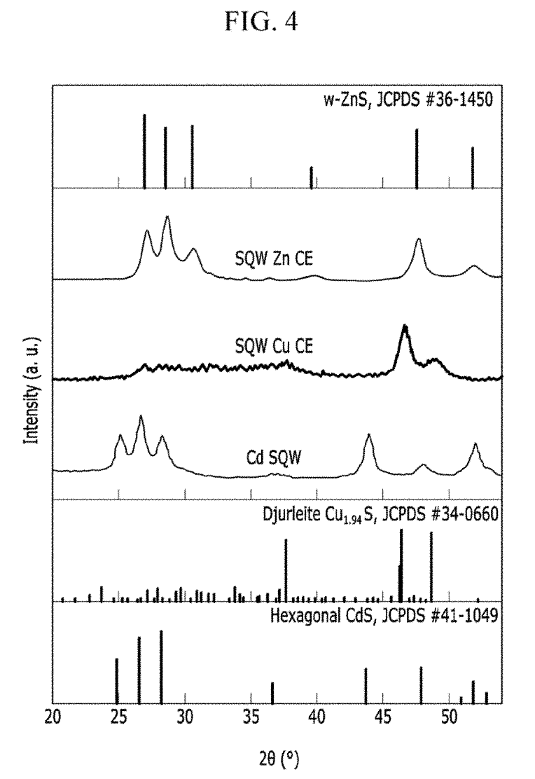

FIG. 4 illustrates a diagram of comparing an XRD pattern of the ZnS/ZnSe/ZnS quantum dot manufactured by the method of an embodiment with XRD patterns of Zn, Cu, and Cd, respectively.

Referring to FIG. 4, it may be seen that peaks of an XRD pattern of the ZnS/ZnSe/ZnS quantum dot manufactured according to an embodiment coincide with peaks of the XRD pattern of Zn and as a result, ion exchange was performed and thus Zn is included in the quantum dot. Further, it may be seen that the peaks corresponding to Cu and Cd are not shown, and Cu or Cd in the quantum dot were ion-exchanged with Zn.

Hereinafter, a manufacturing method of a quantum dot according to another exemplary embodiment will be described. A manufacturing method of a quantum dot according to the present embodiment may include preparing a CdSe/CdS quantum dot including a CdSe-containing core and a CdS-containing shell, forming a Cu₂Se/Cu₂S quantum dot by injecting the CdSe/CdS quantum dot into a solution containing a Cu precursor, and forming a ZnSe/ZnS quantum dot by injecting the Cu₂Se/Cu₂S quantum dot into a solution containing a Zn precursor.

The manufacturing method of the ZnSe/ZnS quantum dot according to the present embodiment is the same as the exemplary embodiment descried above except that the quantum dot has a double structure having a core and a shell of ZnSe and ZnS, rather than a triple structure of ZnS, ZnSe, and ZnS. A repeated detailed description for like constituent elements may be partially omitted.

First, the preparing of the CdSe/CdS quantum dot will be described. For example, CdSe may be in a core at the center of the quantum dot, and CdS may be in a shell positioned along the outside of the CdSe-containing core. In an implementation, a CdS nucleus may be formed in a uniformly spherical shape, and the entire shape of the CdSe/CdS quantum dot may also a sphere. Accordingly, the shape of the ZnSe/ZnS quantum dot manufactured through ion exchange may also be a uniformly spherical shape. When the quantum dot has the uniformly spherical shape, the color purity of the emitted light may be enhanced.

In an implementation, a diameter of the CdSe-containing core in the CdSe/CdS quantum dot may be, e.g., about 2.5 nm to 4.0 nm. In an implementation, a thickness of the CdS-containing shell and/or the ZnS-containing shell may be, e.g., about 0.5 nm to 9.0 nm. For example, the CdS-containing shell may become the ZnS-containing shell through ion exchange thereafter, and the thickness of the CdS-containing shell may be similar to the thickness of the finally manufactured the ZnS-containing shell.

Maintaining the diameter of the core at about 2.5 nm or greater may help ensure that the amount of light emitted is sufficient. Maintaining the diameter of the core at about 4.0 nm or less may help ensure that the size of the quantum dot is not too large. Maintaining the thickness of the shell at about 0.5 nm or greater may help ensure that the internal core is sufficiently protected, thereby helping to prevent an undesirable decrease in the emission efficiency is decreased. Maintaining the thickness of the shell at about 9.0 nm or less may help ensure that the size of the quantum dot is not excessively increased.

Next, the Cu₂Se/Cu₂S quantum dot may be formed by injecting the CdSe/CdS quantum dot into the solution containing the Cu precursor. The Cu₂Se/Cu₂S quantum dot may be formed by ion-exchanging Cd of the CdSe/CdS quantum dot with Cu ions in the solution.

For example, the CdSe/CdS quantum dot may be injected into the solution containing the Cu precursor. In an implementation, the CdSe/CdS quantum dot may be injected in a dispersed state in chloroform. In an implementation, the injection may be performed at ambient temperature, and ion exchange is completed after several seconds elapse. In an implementation, the ion exchange reaction may be performed for about 1 second to 10 seconds, the Cu ions in the solution may be exchanged with Cd in the quantum dot, and the CdSe/CdS quantum dot may become the Cu₂Se/Cu₂S quantum dot.

In an implementation, the solution containing the Cu precursor may include an organic solvent. In an implementation, the organic solvent may include, e.g., methanol, or another suitable organic solvent. In an implementation, the Cu precursor may include, e.g., [Cu (CH₃CN)₄]PF₆⁻, or other suitable materials containing Cu ions.

Next, the ZnSe/ZnS quantum dot may be formed by injecting the Cu₂Se/Cu₂S quantum dot into the solution containing the Zn precursor. The ZnSe/ZnS quantum dot may be formed by ion-exchanging Cu of the Cu₂Se/Cu₂S quantum dot with Zn ions in the solution.

In an implementation, the solution containing the Zn precursor may be heated to a temperature of about 220° C. to 270° C., the Cu₂Se/Cu₂S quantum dot may be injected into the solution, and then the solution may be maintained at the above-described temperature for about 4 to 6 minutes. In an implementation, the Zn ions in the solution may be exchanged with Cu in the quantum dot and thus the Cu₂Se/Cu₂S quantum dot becomes the ZnSe/ZnS quantum dot.

In an implementation, the injection of the Cu₂Se/Cu₂S quantum dot may be performed quickly, and the Cu₂Se/Cu₂S quantum dot may be injected in a state of being dispersed in methanol.

In an implementation, the solution containing the Zn precursor may include an organic solvent. In an implementation, the organic solvent may include, e.g., oleylamine or 1-octadecene. In an implementation, the Zn precursor may include, e.g., ZnCl₂.

In an implementation, in the manufacturing method of the ZnSe/ZnS quantum dot, first, the CdSe/CdS quantum dot may be manufactured and then sequentially ion-exchanged to manufacture the ZnSe/ZnS quantum dot. A CdS nucleus in the CdSe/CdS quantum dot may be formed in a uniformly spherical shape, the entire shape of the CdSe/CdS quantum dot may also be a sphere, and accordingly, the shape of the ZnSe/ZnS quantum dot manufactured through ion exchange may also be a uniformly spherical shape. In an implementation, in the process of manufacturing the CdSe/CdS quantum dot, the thickness of the CdS-containing shell may become or correspond with the thickness of the ZnS-containing shell of the ZnSe/ZnS quantum dot, the ZnSe/ZnS quantum dot (including the ZnS-containing shell having a predetermined thickness) may be manufactured.

Hereinafter, a manufacturing method of a ZnS/ZnSe/ZnS quantum dot according to an exemplary embodiment of the present invention will be described in more detail through detailed Experimental Examples.

### Experimental Example 1: Formation of Cu₂S/Cu₂Se/Cu₂S Quantum Dot by Ion-Exchanging a CdS/CdSe/CdS Quantum Dot

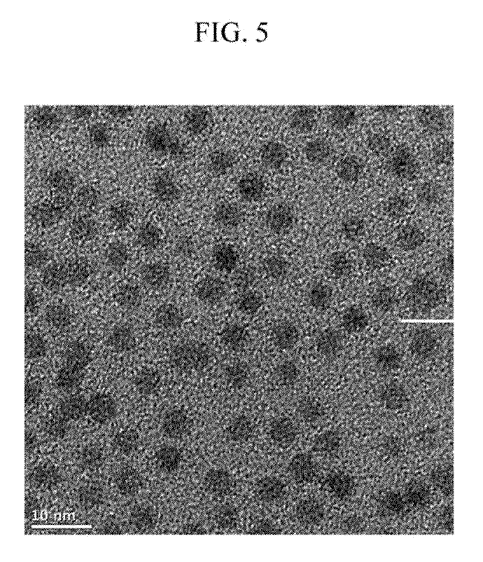

A CdS/CdSe/CdS quantum dot was dispersed in chloroform. FIG. 5 illustrates a TEM image of the CdS/CdSe/CdS quantum dot used in the Experimental Example. Referring to FIG. 5, the CdS/CdSe/CdS quantum dot having a uniformly spherical shape can be seen.

The CdS/CdSe/CdS quantum dot dispersed in chloroform was injected into a solution in which tetrakis(acetonitrile)copper(I) hexafluorophosphate ([Cu (CH₃CN)₄]PF₆⁻) and an excess of methanol were mixed.

After several seconds elapsed at ambient temperature, an ion exchange reaction of Cd and Cu was completed. A Cu₂S/Cu₂Se/Cu₂S quantum dot was formed by the ion exchange reaction.

Next, the solution mixed with the Cu₂S/Cu₂Se/Cu₂S quantum dot was purified using methanol through centrifugation and dispersed in chloroform again. An image of the Cu₂S/Cu₂Se/Cu₂S quantum dot manufactured by the Experimental Example was illustrated in FIG. 5.

### Experimental Example 2: Formation of ZnS/ZnSe/ZnS Quantum Dot by Ion-Exchanging Cu₂S/Cu₂Se/Cu₂S Quantum Dot

A mixed solution in which oleylamine, 1-octadecene, and ZnCl₂ were mixed was prepared. Gas was removed from the mixed solution at ambient temperature and in a vacuum state.

Next, the mixed solution was heated to 250° C. The Cu₂S/Cu₂Se/Cu₂S quantum dot dispersed in chloroform (manufactured in Experimental Example 1) and trioctylphosphine were rapidly injected into the heated mixed solution.

The temperature of the mixed solution injected with the Cu₂S/Cu₂Se/Cu₂S quantum dot and the trioctylphosphine was maintained at 250° C. for 5 minutes and the ion exchange reaction of Cu and Zn was completed. A ZnS/ZnSe/ZnS quantum dot was formed by the ion exchange reaction.

Next, the solution mixed with the ZnS/ZnSe/ZnS quantum dot was purified using methanol through centrifugation and dispersed in toluene.

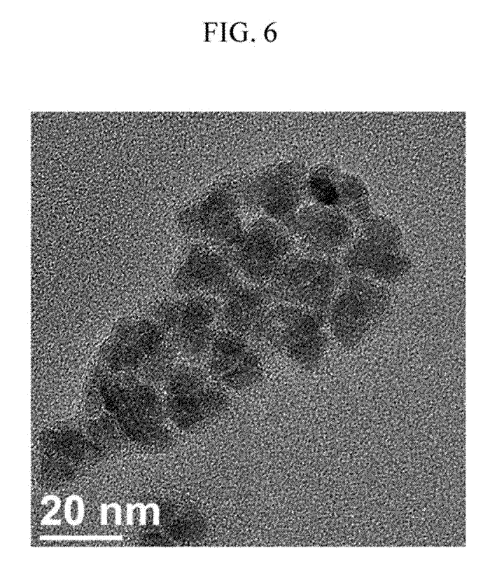

An image of the ZnS/ZnSe/ZnS quantum dot manufactured by Experimental Example 2 is illustrated in FIG. 6.

By way of summation and review, using quantum dot in a wide range of applications, e.g., various fields including displays, solar energy conversion, molecular and cellular imaging, and the like has been considered.

For example, a quantum dot that may be applied to the display field to emit blue light may include CdSe/ZnS, InP/ZnS, and the like. Cadmium may be harmful as a toxic material. In addition, in the case of InP, it may not be easy to synthesize the InP by adjusting a diameter to less than 1 mm.

The embodiments may provide a method of manufacturing a quantum dot through ion exchange.

The embodiments may provide a method for easily manufacturing a quantum dot of a ZnS/ZnSe/ZnS structure or a quantum dot of a ZnSe/ZnS structure through ion exchange.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of manufacturing a quantum dot, the method comprising:
preparing a CdS/CdSe/CdS quantum dot that includes a CdS-containing first core, a CdSe-containing second core, and a CdS-containing shell;
forming a Cu₂S/Cu₂Se/Cu₂S quantum dot by injecting the CdS/CdSe/CdS quantum dot into a solution containing a Cu precursor; and
forming a ZnS/ZnSe/ZnS quantum dot by injecting the Cu₂S/Cu₂Se/Cu₂S quantum dot into a solution containing a Zn precursor.

2. The method as claimed in claim 1, wherein:
the ZnS/ZnSe/ZnS quantum dot includes a ZnS/ZnSe-containing core and a ZnS-containing shell, and
a thickness of the ZnS-containing shell is 0.5 nm to 4.0 nm.

3. The method as claimed in claim 1, wherein:
a diameter of a ZnS-containing first core in the ZnS/ZnSe/ZnS quantum dot is 0.5 nm to 4.0 nm, and
a thickness of a ZnSe-containing second core in the ZnS/ZnSe/ZnS quantum dot is 1.0 nm to 4.0 nm.

4. The method as claimed in claim 1, wherein forming the Cu₂S/Cu₂Se/Cu₂S quantum dot is performed at ambient temperature for 1 to 10 seconds.

5. The method as claimed in claim 1, wherein the solution including the Cu precursor includes Cu ions dispersed in an organic solvent.

6. The method as claimed in claim 5, wherein the solution including the Cu precursor includes [Cu (CH₃CN)₄]PF₆⁻ dispersed in methanol.

7. The method as claimed in claim 1, wherein forming the ZnS/ZnSe/ZnS quantum dot is performed at a temperature of 220° C. to 270° C. for 4 to 6 minutes.

8. The method as claimed in claim 1, wherein the solution including the Zn precursor includes Zn ions dispersed in an organic solvent.

9. The method as claimed in claim 8, wherein the solution including the Zn precursor includes ZnCl₂ dispersed in at least one of oleylamine and 1-octadecene.

10. A method of manufacturing a quantum dot, the method comprising:
preparing a CdSe/CdS quantum dot that includes a CdSe-containing core and a CdS-containing shell;
forming a Cu₂Se/Cu₂S quantum dot by injecting the CdSe/CdS quantum dot into a solution containing a Cu precursor; and
forming a ZnSe/ZnS quantum dot by injecting the Cu₂Se/Cu₂S quantum dot into a solution containing a Zn precursor.

11. The method as claimed in claim 10, wherein:
the ZnSe/ZnS quantum dot includes a ZnSe-containing core and a ZnS-containing shell, and
a thickness of the ZnS-containing shell is 0.5 nm to 9.0 nm.

12. The method as claimed in claim 10, wherein a diameter of a ZnSe-containing core in the ZnSe/ZnS quantum dot is 2.5 nm to 4.0 nm.

13. The method as claimed in claim 10, wherein forming the Cu₂Se/Cu₂S quantum dot of is performed at ambient temperature for 1 to 10 seconds.

14. The method as claimed in claim 10, wherein the solution including the Cu precursor includes Cu ions dispersed in an organic solvent.

15. The method as claimed in claim 14, wherein the solution including the Cu precursor includes [Cu (CH₃CN)₄]PF₆⁻ dispersed in methanol.

16. The method as claimed in claim 10, wherein forming the ZnSe/ZnS quantum dot of is performed at a temperature of 220° C. to 270° C. for 4 to 6 minutes.

17. The method as claimed in claim 10, wherein the solution including the Zn precursor includes Zn ions dispersed in an organic solvent.

18. The method as claimed in claim 17, wherein the solution including the Zn precursor includes ZnCl₂ dispersed in at least one of oleylamine and 1-octadecene.
